(19) United States
(12) Patent Application Publication
(10) Pub. No.: US 2014/0122614 A1
(43) Pub. Date: May 1, 2014

(54) Cooperation In An Application Store Environment

(71) Applicant: F-SECURE CORPORATION, Helsinki (FI)

(72) Inventors: Arto Saari, Helsinki (FI); Harri Kiljander, Helsinki (FI)

(73) Assignee: F-Secure Corporation, Helsinki (FI)

(21) Appl. No.: 13/666,493

(22) Filed: Nov. 1, 2012

(51) Int. Cl. H04L 29/08

(52) U.S. Cl. CPC H04L 67/10
USPC 709/205

(57) ABSTRACT

A way is shown for network operators to collaborate in promoting an application. A mediator publishes the application in an application store and the collaborating network operators promote it. The published application is provided to requesting user devices via the application store; and for each of them that is associated with one of the collaborating network operators, the provided application is re-branded with configuration information specific for the network operator associated with the respective user device. In some embodiments the application in the store is branded, if at all, with a default brand that is not specific to any collaborating network operator, and this default brand may be of the collaboration or of the mediator. The configuration information changes the default brand and/or look and feel of the application to that selected by the collaborating network operator that is associated with the respective user device.

### TECHNICAL FIELD

The invention relates to the field of providing a choice of software downloads from a common online portal such as applications from an application store.

### BACKGROUND

Online portals through which users of mobile electronics can shop among a wide variety of downloadable software are well known and sometimes referred to as over-the-top OTT application store environments, and there are only a select few application stores that are currently quite popular such as for example Apple's AppStore, Google Play, and the Microsoft Windows Store and Marketplace. These software applications (apps) are generally characterized as being relatively small in size, typically on the order of a few or tens of megabytes. The owner/operators of these conventional application stores allow third parties (the individual software/app publishers) to make their software available through the application store. For example, software applications available through such an online software portal/store may be provided by handset/smart phone vendors such as Samsung and Nokia; cellular service providers such as Verizon, Telefonica and China Mobile, and by third parties such as Intel, Facebook and Amazon.com, to name a few. This has generally proven to be mutually beneficial; a wider variety of apps available through a single application store draws in a larger volume of customers, and the third party application developers have access to a pre-existing worldwide distribution platform at little expense. Like brick and mortar retail stores, the application store owner/operator may exercise some quality control over these products provided in its store by third parties and so may check for malware or compatibility with a common operating system or related programs, but it does not appear that these application stores directly alter the content of the applications provided by the third parties.

Many software applications are now developed for or by cellular service providers (CSP) such as for example Verizon, Telefonica and China Mobile, Internet service providers (ISP) and mobile network operators (MO). These larger corporate entities have attempted to develop their own application stores separate from few popular application portals noted above. The Wholesale Application Community WAC is one joint venture example of this. The reason is that the conventional OTT application store model may in some cases puts at risk their revenue stream from licensed subscription services associated with certain applications, such as for example news feeds or anti-virus services. These efforts to develop separate application stores have not yet found substantial commercial success.

What is needed in the art is a different model for the application store as portal between the software publishers and the downloading end users, particularly when the application(s) is provided by a CSP, ISP or MO.

### SUMMARY

In accordance with one exemplary aspect of these teachings there is a method for network operators to collaborate in promoting an application that is available in an application store. In this aspect the method comprises: publishing by a mediator the application in the application store; at least some of the collaborating network operators promoting the published application; providing the published application to requesting user devices via the application store; and for each of the requesting user devices that are associated with one of the collaborating network operators, re-branding the provided application with configuration information specific for the collaborating network operator that is associated with the respective user device.

In accordance with another exemplary aspect of these teachings there is a computer readable memory storing a set of executable instructions. In this aspect the set of instructions comprises: code for publishing a software application in an online application store on behalf of a collaboration of network operators; code for providing the published application to requesting user devices via the application store; code for associating at least some of the requesting user devices to individual ones of the network operators of the collaboration; and code for re-branding the provided application with configuration information specific for the network operator of the collaboration with which the respective user device is associated.

In accordance with a still further exemplary aspect of these teachings there is an apparatus comprising at least one memory storing a set of computer executable instructions, and at least one processor. In this aspect the memory with the set of computer executable instructions is configured with the at least one processor to cause the apparatus to at least: publish a software application in an online application store on behalf of a collaboration of network operators; provide the published application to requesting user devices via the application store; associate at least some of the requesting user devices to individual ones of the network operators of the collaboration; and cause the provided application to be re-branded with configuration information specific for the network operator of the collaboration with which the respective user device is associated. By way of example such an apparatus may be a server operated by the mediator/publisher as will be further detailed in the next section, or one or more components of such a server.

These and other aspects are detailed more particularly below.

### BRIEF DESCRIPTION OF THE DRAWINGS:

FIG. 1 is a schematic overview of an Application (App) Store in which several user devices are shopping for an app that is cooperatively marketed and provided to the users according to these teachings, where different user devices are subscribers to different operators all of which are coalition partners for the cooperative marketing.

FIG. 2 is a schematic block diagram of certain entities shown at FIG. 1 which are exemplary electronic entities/nodes/devices for practicing embodiments of these teachings.

FIG. 3 is a conceptual overview of the application store with three different coalition operators and three different user devices downloading the same app which will present to those different users with different operator-specific branding and/or different look and feel according to an exemplary embodiment of these teachings.

FIG. 4 is a schematic flow diagram illustrating an app first launched at a user device and how the branding for a specific operator becomes associated to the downloaded app.

FIG. 5 is a diagram illustrating features of an example method.

### DETAILED DESCRIPTION:

Operators such as cellular service providers, Internet service providers and mobile operators have not yet tried joint marketing inside an OTT application store, which would link the power of an already-established and well-known application store with the combined efforts of these operators to gain visibility for their services. But many of these CSPs/ISPs/MOs are marketplace competitors, so for a joint marketing operation to be viable there must be some structure to keep the application store (or at least the relevant software applications in it) as a non-competitive, neutral environment. One way these teachings facilitate this is to enable each operator to retain its own brand throughout the end user's experiences related to the application store, and to ensure the operators are allocated revenue for the subscribers which they drive to the application store, so as to enable marketing collaboration among by-nature competitive entities.

There are a variety of stakeholders which may benefit from participating in these teachings. The network operators are noted above, but there will also be a publisher/mediator which is the entity which is responsible for publishing the (multi-branded) application to the online application store. As will be detailed below, to assure the application store is a marketing neutral environment among the interested parties (at least concerning the jointly-marketed application(s) that are in the application store), in certain embodiments this publisher/mediator is not also a network operator since the mediator's brand may be used as a default brand on the application, prior to re-branding it. In any case the publisher/mediator is also responsible for assuring the agreed revenue sharing among the other parties, at least for those embodiments in which include revenue sharing. There is also the vendor of the software application itself, which may in some instances be the same as the publisher/mediator or in other instances the publisher/mediator can contract with a third party to develop and deliver the software application to the publisher/mediator for publication in the application store. And finally the application store provider is the host party of the application store to which the application is published and made available to the retail end users.

According to embodiments of these teachings the individual operators are free to market the software applications through whatever channels they see fit outside the application store; for example the Internet, an e-store, print, and other media marketing. If for example the marketing collaboration is for a mobile security application, all CSPs, ISPs and MOs can market the exact same software application that is available in the application store, and once downloaded to the user devices there would be only surficial branding-type differences that are visible to the end user but which do not represent any difference in the underlying software's functionality. Such differences can be as little as a logo or as substantial as the overall look and feel of the software application's graphical user interface, but the underlying functionality need not be altered in this re-branding. In essence all the participating operators would be marketing the same underlying product/software application, but once purchased by the end user these software applications would exhibit the respective operator's own marketing message and/or brand.

In this manner the individual marketing efforts of the different operators will combine to back up and enhance each other's marketing of the same application that is available in an application store, resulting in increased visibility inside the application store and tending to attract more end users as potential buyers of the software application (or of its subscription services). Traditionally, network operators have sold separate products with no potential for enhancing visibility or market reach through joint marketing.

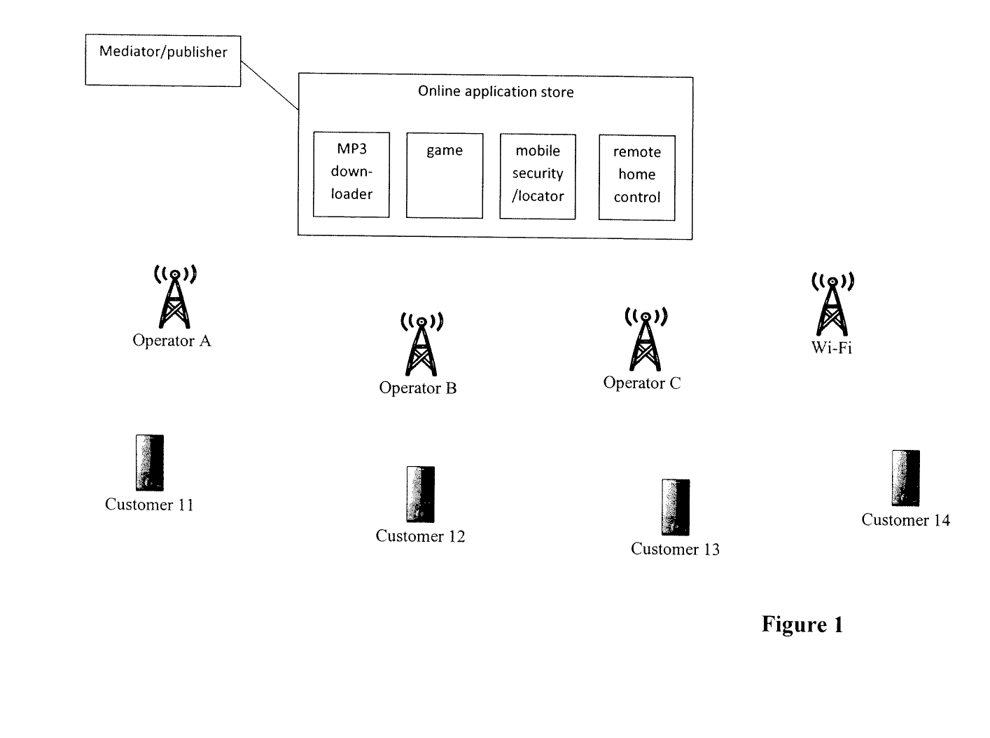

FIG. 1 is a schematic overview of an application store which is explained according to an example embodiment of these teachings. Shown in the online application store are four software applications: a MP3 downloader, a game, a mobile security/smartphone locator application, and an application for remotely controlling lighting or security or some other functions in one's home. To better illustrate the flexibility of these teachings assume the MP3 downloader and the mobile security are the jointly marketed applications that will be separately branded once on the user devices, and the game and remote home controller are conventional applications that may be in competition with other similar functioning applications that are also available in the application store. While these assumptions make clear that the joint marketing concept can co-exist even alongside conventional applications in a same application store, in other embodiments it may be that several of the CSPs and MOs agree to establish a new application store operated entirely according to these teachings such that every one of the software applications available there are both jointly marketed and separately branded when on the user devices. As will be seen, in some embodiments such applications can be published to a pre-existing application store with no special consideration by the application store which will treat it conventionally, and all the inventive aspects may be transparent to the application store owner/operator in certain embodiments.

For convenience let us refer to the operators that collaborate in the joint marketing and separate branding of software applications in this application store as an operator coalition, which in FIG. 1 hypothetically include Operator A, Operator B and Operator C. There is a mediator or publisher in FIG. 1 which in the business model provides mediator service to the operator coalition. Specifically, the mediator provides the application, publishes it to the application store and handles or otherwise allocates revenue sharing between partners (where revenue sharing is used). In the FIG. 1 example the mediator/publisher provides to the application store only the MP3 downloader and the mobile security application; the other two are provided by other third parties and are conventional.

Customer 11 is a customer of Operator A and in this example accesses the application store via operator A. Even if the customer 11 is roaming and the actual connection to the application store goes through some roaming operator, the customer 11 can be associated with operator A to which it subscribes through its IMSI (or more specifically, from codes extracted from the IMSI), as will be detailed below. Similarly customer 12 is a subscriber of operator B and customer 13 is a subscriber of operator C so those customers are associated with those respective operators s to the application purchase.

Customer 14 may or may not be a subscriber to one of the coalition operators; at the time it accesses the application store it does so via a Wi-Fi connection. Regardless, customer 14 can still be associated with the coalition operator to which it subscribes if in fact its subscription is with a coalition operator, but this association may be delayed until the customer 14 device makes a network connection through some cellular network operator, at which time the user device will store the operator's brand information in a local memory cache for future use with the previously-downloaded application. Until then the downloaded application can launch on the customer 14 device with a default brand with which it was downloaded. If the device used by customer 14 is not a subscriber of any cellular network operator (e.g., it is a Wi-Fi only device) then the downloaded application can be branded with that of the mediator/publisher (so long as the mediator/publisher is not also a competitor to the operators for their subscriber base), or with some other default branding such as a brand developed for the coalition of operators as a whole. Association of the individual customers/user devices with the individual operators can be done via the device's 15 digit International Mobile Subscriber Identity (IMSI) which carries the Mobile Country Code (MCC) and Mobile Network Code (MNC), as will be detailed more particularly at co-owned US patent application publication 2011/0087757 (published on Apr. 14, 2011). That co-owned US patent application publication 2011/0087757 is hereby incorporated by reference in its entirety. Some network operators or user devices may not provide the entire IMSI to querying entities and instead only provide the mobile country code (MCC) and mobile network code (MNC); these two codes alone are sufficient according to these teachings to identify the specific network operator associated with a given user device that is requesting or that has downloaded and is now launching the relevant software application.

The mediator/publisher may or may not also be an operator, but gains certain advantages due to its additional responsibilities noted above. Such advantages include in certain embodiments the opportunity to co-brand with the operators (assuming the mediator/publisher is not an operator), and increased revenue from the services it provides as the central sales partner for the relevant application or applications in the application store.

Because the same application is downloaded to customers there is also an advantage for the underlying developers of the software applications in that they no longer need to provide customized variants of their application to their different operator customers. This can result in a net development cost reduction which can translate to a higher profit margin for the application developers or a lower cost to the mediator/publisher which procures the applications for publication to the application store. This also enables a simplified pathway to launch new product and service concepts, either inside the security space of the online application store or elsewhere.

These teachings can be deployed with a wide variety of business models and software applications, including paid applications, freemium, continuous services, etc. The software delivery concept detailed herein is agnostic across these dimensions.

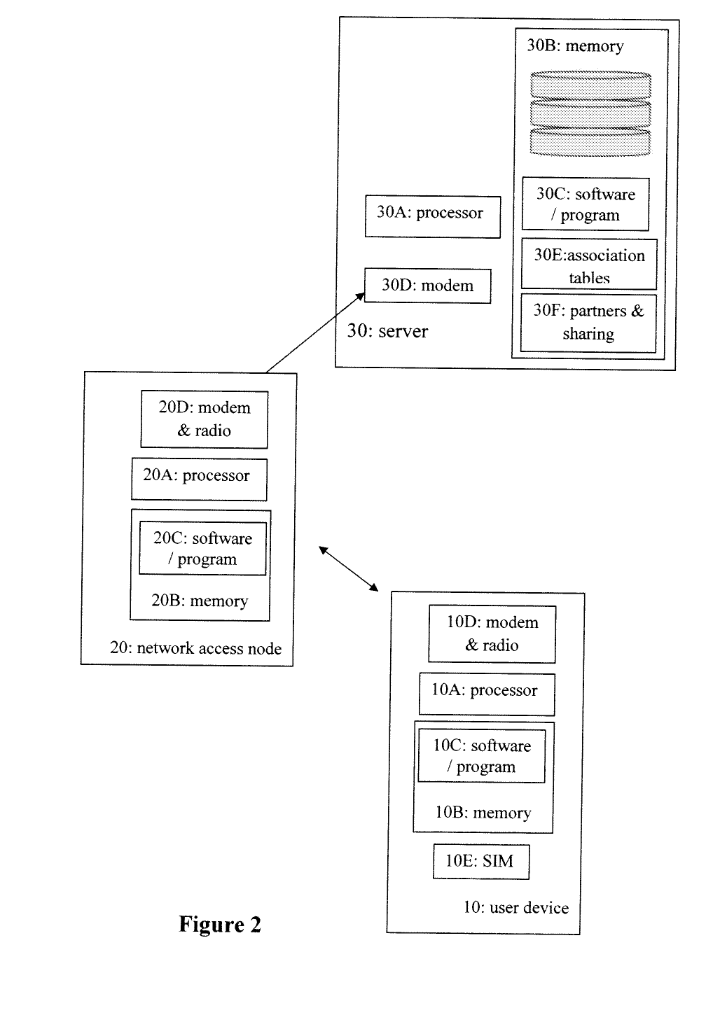

Before further detailing how the same software application may be branded differently on the user devices depending upon which operator is associated with the downloading customer/device, reference is made to FIG. 2 which details a high level schematic diagram of the involved electronic nodes. User device 10 represents any portable user radio device such as a smartphone, tablet computer, laptop computer, wearable computer and the like, and includes at least one digital processor 10A, at least one computer readable memory 10B storing a set of computer executable programs 10C, a radio with modem 10D for two way wireless communication with a radio access network, and a subscriber identity module (SIM) 10E which carries the device's unique IMSI.

There is also shown at FIG. 2 a network access node 20 which also has its own at least one digital processor 20A, at least one computer readable memory 20B storing a set of computer executable programs 20C, and a radio with modem 20D for two way wireless communication with user devices such as the illustrated device 10.

The server 30 shown at FIG. 2 is in the position of the mediator/publisher of FIG. 1, but in some embodiments the mediator/publisher can also be operating the application store shown at FIG. 1. The server 30 includes at least one digital processor 30A, at least one computer readable memory 30B storing a set of computer executable programs 30C, and a modem 30D for two way communications over the Internet. Communications between the user device 10 and the server (in the position of the application store) pass through the network access node 20 and other nodes of the operator's radio access network, and then typically through a core network for routing to the Internet and the server 30. The server further stores in its memory 30B association tables 30E that show which customers/user devices are associated with which operators, and at 30F store information about the coalition partners (including the coalition operators and the mediator/publisher) for revenue sharing and/or other formalized agreements that are relevant to the software applications and customers/user devices.

From the user's perspective, application discovery, purchase and download happens in the selected application store. Branding of the software application, as viewed by the end user customer while shopping in the application store, is not operator specific since the same application can have different operator's brands once downloaded to a specific user device 10. So in the listing of software applications in the application store as seen by the end user shoppers, the relevant applications do not carry any operator-specific brand but may for example exhibit a brand for the operator coalition as a whole, or of the mediator/publisher so long as the mediator/publisher is not also a CSP, ISP or MO in competition with another operator, or some other default brand that gives no marketing advantage to one operator over another. In this manner the software applications according to these teachings, when they are in application store itself, are marketing neutral among all of the coalition partners. Where the coalition partners have no other applications apart from those that follow these teachings, then the entire application store is marketing neutral among the coalition partners.

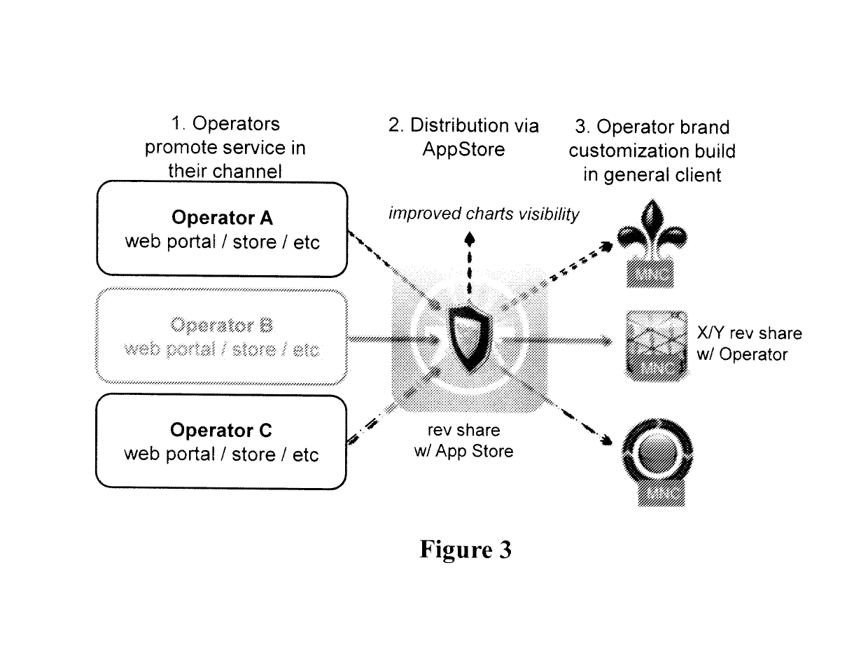

FIG. 3 illustrates a conceptual overview of this marketing-neutral application store environment. Operators A, B and C from FIG. 1 are free to promote the services they offer via the software applications, or the apps themselves, through any marketing channel they see as effective. The applications that are marketed by the different operators, which from the FIG. 1 example was the MP3 downloader and the mobile security application, are distributed to shoppers who've visited the application store due to the marketing or for whatever reason. In an embodiment of these teachings, after downloading the software application, when the end user takes the newly downloaded application into use for the first time (that is, when the application is opened for the first time on the user device 10) then the operator-specific branding will be applied.

Assume that for FIG. 3 customers 11, 12 and 13 each download the mobile security application. Prior to downloading they each see the identical mobile security application in the application store. The underlying software application they download is functionally identical. In an embodiment, the only difference among the mobile security application as it resides in the local memory of customer devices 11, 12 and 13 becomes manifest only after the mobile security software application is first launched on these different devices. At that time the branding for operator A will be applied to the mobile security application that is resident on customer device 11 because customer 11 is a subscriber of, and is associated for purposes of this software application, with operator A. Similarly, after launching the application the branding for operator B will be applied to the mobile security application that is resident on customer device 12 and the branding for operator C will be applied to the mobile security applications that is resident on customer device 13.

Similar holds true if customer device 14 were to download and launch the mobile security application, but in this case there are two options. If customer device 14 is a subscriber to some coalition operator A, B or C, then upon first launch of the application that operator's branding will be applied same as detailed above for customer devices 11, 12 and 13. If customer device 14 is a subscriber to some operator that is not a coalition partner, then the operator-non-specific branding that was exhibited to shoppers in the application store can remain and will not be changed upon first launch of the software application by customer device 14. For example, that default and operator-non-specific branding may be for the coalition itself or for the mediator/publisher.

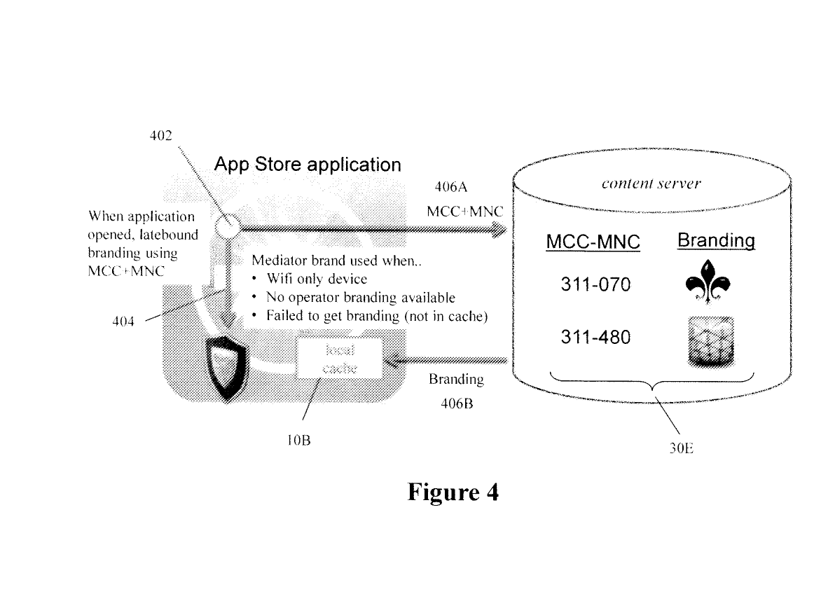

FIG. 4 gives a schematic overview of one embodiment of the branding customization process. The application (of the iOS® type in FIG. 4) has been downloaded and is resident in the local memory of a user device. Assume that the brand or logo of the mediator/publisher (a shield is shown for this purpose at FIGS. 3-4) is what is visible to the user devices when shopping in the application store.

The branding customization process is dependent on identifying the operator in the application. This is done for example by using the Mobile Country Code (MCC) and the Mobile Network Code (MNC) from the user device's IMSI, or the MCC and MNC provided by the home network operator if such operator does not provide the entire IMSI, or by other identifiers that may be used to associate a user device 10 on which the relevant client software application has been downloaded to a specific network operator. From these codes or identifiers then there is an automatic configuration of the client application at the user device 10 by identifying the user's operator. The user's operator may be any type of network operator, examples of which include a Mobile Network Operator (MO), a Virtual Mobile Network Operators (MVNO), a local fixed line network owner, or any other type of network operator that has a registered MNC or is otherwise identifiable by some other code which can be used to associate it with a user device on which the client application has been downloaded. Automatic configuration allows the client application to automatically adapt its user interface look-and-feel, and/or branding settings to match the device operator's preferences.

As noted above, in one embodiment of the invention identification of the operator is performed using the IMSI. An IMSI is typically 15 digits long. The first three digits of the IMSI denote the Mobile Country Code (MCC), and the next two (in European standards) or three (in North American standards) digits denote the Mobile Network Code (MNC). The remaining digits denote the mobile station identification number (MSIN) within the identified network. In other embodiments the IMSI is not provided by the user device or its home network but only the MCC and MNC are provided.

The client application attempts to obtain the MCC and the MNC from the SIM 10E of the user device 10 when the application is first activated/launched at 402 of FIG. 4, or at least obtains the MCC and MNC. If for example at 404 of FIG. 4 the user device is a Wi-Fi only device (that is, no cellular capability and no MCC or MNC in the unique device identifier), or if the MCC and MNC for this device 10 do not match up in the association table 30E with a coalition operator, or if the matched coalition operator's branding/logo is not in the local cache/memory 10B of the user device, or if there is some communication failure that the messages 406A and/or 406B do not go through, then the default branding and/or look and feel of the application which was embedded in the software application as downloaded from the application store, and which was visible to shoppers there, will be retained for the application while that application is put into use in the user device 10.

If the client application is able to obtain the MCC and the MNC when the application is first activated at 402 of FIG. 4, then the user device/application sends this information in an activation message 406A to the server 30. The server 30 receives the message 406A and the server's processor 30A uses the MCC and the MNC to enter the association table 36E in the server's memory 30B so as to identify the network operator for the user device 10. Note the memory 30B may be resident in the physical server or remote therefrom and accessible via busses or other communication channels. This database/table 30E returns the branding (shown as operator logos in the association table 30E at FIG. 4) and possibly also any operator-specific look and feel for the application. Once the operator-specific branding and/or look and feel have been obtained, they are communicated to the user device 10 at message 406B. The downloaded application uses the operator-specific branding and/or look and feel settings to configure itself to ensure that it is presenting itself to the user of the user device 10 in accordance with the requirements of the operator associated with that device.

The above description assumes that the client application is configured when it is first activated, although in an alternative embodiment this may occur at any time when the application is run. This allows the downloaded application to change its configuration “on the fly” and take account of any changes over time that may be made to the operator-specific branding and/or look and feel settings. This also enables the application to have the operator's branding and/or look and feel applied if for example there was a communication failure when the application was initially launched and messages 406A and/or 406B did not go through at that time. This periodic refreshing can be implemented in any number of ways; every time the software application is launched; every time the application is launched but no more frequently than once a week, etc.

Further specifics as the configuring the application on first launch or on the fly may be seen in co-owned US patent application publication 2011/0087757, and particularly the signaling diagram at FIG. 2 of that publication which gives further detail than that shown at FIG. 4 of this document.

All sales of the software application occur inside the application store. In one embodiment the application store debits the revenue (minus any share due to the application store share, and possibly also taxes in certain jurisdictions) to the application publisher, which in this case is also the mediator shown at FIG. 1. The mediator's licensing arm tracks the operator-specific sales at the back end for use as the basis of revenue share, for the case that revenue share is employed.

Following is an exemplary flow for a business model according to these teachings:

Step 1. The application and business model are chosen based on operator strategy focus. This consideration takes into account the operator partner candidates and their market segment. Some possibilities include:
Operators introducing a new type of mobile application service (e.g. video streaming, password protection)
Operators targeting a new market area (e.g. Europe/Middle-East/Africa EMEA region, Asia/Pacific APAC region, some specific country)
Operators looking to leverage new business models in mobile (e.g. freemium, subscription service)

Step 2. Operator partner negotiations. This entails initial partnerships for go-to-market on the selected application. Initial operator partners are committed to market the application, potentially with joint marketing effort sharing the same campaign materials, etc. Key topics may include:
Market co-operation planning
Revenue sharing policy
Application client branding
Localization planning

Step 3. Rollout and operation. After partnerships on the marketing plan have been resolved, the mediator acts as publisher and sales agent of the application. Support and maintenance are provided by the publisher. Operational key points include but are not limited to:
Monthly-based revenue share according to the agreed revenue share policy
Application upgrades are to be provided by the mediator/publisher.
Collective requirement management between the partners based on customer feedback on further improving the application.

Step 4. Partner expansion. Based on commercial success of the application, more operator partners can be added to the collaboration. Their brand customization is added to the application. Some of the key features for expanding the partnership include but are not limited to:
The operator's subscribers are already purchasing the application (revenue is generated already but is not shared to the partner).
Effectiveness of joint marketing and the foundation created by the initial partners.
Overall commercial success.

Step 5. End of life. Each application has its commercial lifecycle and will result in some end of life, typically dictated by the market. On commercial success the end of life may occur later in time when there are already transitions to new applications and the partnership coalition may continue with those new products/applications. For commercial failures the end of life may be jointly agreed at an earlier time.

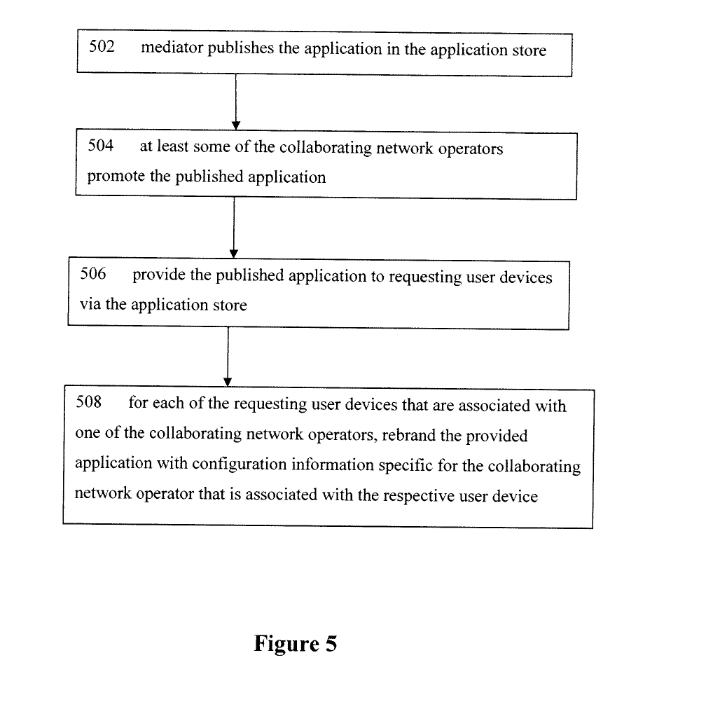

FIG. 5 is a logical flow diagram that illustrates an exemplary but non-limiting embodiment of these teachings for network operators to collaborate in promoting an application that is available in an application store. At block 502 the mediator publishes the application in the application store, and at block 504 at least some of the collaborating network operators promote the published application. Typically all collaborating operators will market or otherwise promote the application but in some circumstances perhaps one or two operators will bring other advantages to the group and may not be obligated to promote, particularly if their own subscriber base is small. At block 506 the published application is provided to requesting user devices via the application store; and at block 508, for each of the requesting user devices that are associated with one of the collaborating network operators, the provided application is re-branded with configuration information specific for the collaborating network operator that is associated with the respective user device. As noted above, if there is a user device such as a Wi-Fi only device that is not associated with any network operator then that device will not have its downloaded application re-branded.

As a summary of some of the more detailed implementations above, in some embodiments the application as published in the application store is branded, if at all, with a default brand that is not specific to any network operator that is collaborating. In the examples above the default brand is for at least one of the collaboration of network operators, or the mediator.

In another embodiment detailed above the configuration information changes at least one of the default brand and a look and feel of the application to a respective brand and a look and feel of the application that is selected by the collaborating network operator that is associated with the respective user device. In the examples above, each of the requesting user devices are associated with one of the collaborating network operators in an association table maintained by the mediator, a mobile network code of the network operator with which the respective user device is a subscriber. The configuration information is selected from the association table based on at least part of the IMSI or other unique identifier of the respective user device or the MNC (and possibly also the MCC), and the configuration information is then downloaded to the respective requesting user device automatically in response to an initial launch of the application on the respective user device.

In other embodiments of these teachings in which revenue sharing is employed, the mediator allocates respective shares of revenue generated by the application among the respective collaborating network operators, wherein the respective shares of revenue that are allocated is based on the association of the requesting user devices with respective collaborating network operators.

The specific elements of FIG. 5 may be considered as steps of a method according to these teachings, of specific logical code of a set of computer executable instructions that are stored in or on a computer readable memory, or actions taken or functions executed by an apparatus that has one or more processors to execute such computer code stored on a memory. Such an apparatus can be a server operated by the mediator, or by the application store itself, or a combination of them both (in which there may or may not be intermediate entities/servers between them).

It will be appreciated by the person of skill in the art that various modifications may be made to the above-described embodiments without departing from the scope of the invention. For example, the above description describes identifying the network operator using the MCC and MNC, but other user device identifiers may be used as well as other types of identifiers that are used or known by the user device such as the MSISCN number which identifies its operator network. Alternatively the home network associated with the user device can be identified as the associated network operator; core networks of radio access networks can already obtain this home network information for a user device for roaming purposes.

We claim:

1. A method for network operators to collaborate in promoting an application that is available in an application store, the method comprising:
publishing by a mediator the application in the application store;
at least some of the collaborating network operators promoting the published application;
providing the published application to requesting user devices via the application store; and
for each of the requesting user devices that are associated with one of the collaborating network operators, re-branding the provided application with configuration information specific for the collaborating network operator that is associated with the respective user device.

2. The method according to claim 1, wherein the application as published in the application store is branded, if at all, with a default brand that is not specific to any network operator that is collaborating in the method.

3. The method according to claim 2, wherein the default brand is for at least one of the collaboration of network operators or the mediator.

4. The method according to claim 2, wherein the configuration information changes at least one of the default brand and a look and feel of the application to a respective brand and a look and feel of the application that is selected by the collaborating network operator that is associated with the respective user device.

5. The method according to claim 1, wherein each of the requesting user devices are associated with one of the collaborating network operators in an association table maintained by the mediator, the configuration information is selected from the association table based on at least a mobile network code of the network operator with which the respective user device is a subscriber, and the configuration information is downloaded to the respective requesting user device automatically in response to an initial launch of the application on the respective user device.

6. The method according to claim 1, further comprising the mediator allocating respective shares of revenue generated by the application among the respective collaborating network operators, wherein the respective shares of revenue is based on the association of the requesting user devices with respective collaborating network operators.

7. A computer readable memory storing a set of executable instructions comprising:
code for publishing a software application in an online application store on behalf of a collaboration of network operators;
code for providing the published application to requesting user devices via the application store;
code for associating at least some of the requesting user devices to individual ones of the network operators of the collaboration; and
code for re-branding the provided application with configuration information specific for the network operator of the collaboration with which the respective user device is associated.

8. The computer readable memory according to claim 7, wherein the application as published in the application store is branded, if at all, with a default brand that is not specific to any network operator of the collaboration.

9. The computer readable memory according to claim 8, wherein the default brand is for at least one of the collaboration of network operators or of a mediator which operates to publish the application.

10. The computer readable memory according to claim 8, wherein the configuration information changes at least one of the default brand and a look and feel of the application to a respective brand and a look and feel of the application that is selected by the network operator of the collaboration that is associated with the respective user device.

11. The computer readable memory according to claim 7, wherein:
the code for associating operates to compile an association table in which each of the at least some of the requesting user devices are associated with an individual one of the network operators of the collaboration, and
the code for re-branding operates to select the configuration information from the association table based on at least a mobile network code of the network operator with which the respective user device is a subscriber, and the configuration information is downloaded to the respective requesting user device automatically in response to an initial launch of the application on the respective user device.

12. The computer readable memory according to claim 7, wherein the set of executable instructions further comprises:
code for allocating respective shares of revenue generated by the application among the respective network operators of the collaboration, wherein the respective shares of revenue is based on the association of the requesting user devices with respective network operators of the collaboration.

13. An apparatus comprising at least one memory storing a set of computer executable instructions and at least one processor, wherein the memory with the set of computer executable instructions is configured with the at least one processor to cause the apparatus to at least:
publish a software application in an online application store on behalf of a collaboration of network operators;
provide the published application to requesting user devices via the application store;
associate at least some of the requesting user devices to individual ones of the network operators of the collaboration; and
cause the provided application to be re-branded with configuration information specific for the network operator of the collaboration with which the respective user device is associated.

14. The apparatus according to claim 13, wherein the application as published in the application store is branded, if at all, with a default brand that is not specific to any network operator of the collaboration.

15. The apparatus according to claim 14, wherein the default brand is for at least one of the collaboration of network operators or of a mediator which operates to publish the application.

16. The apparatus according to claim 14, wherein the configuration information changes at least one of the default brand and a look and feel of the application to a respective brand and a look and feel of the application that is selected by the network operator of the collaboration that is associated with the respective user device.

17. The apparatus according to claim 13, wherein:
the associating comprises compiling an association table in which each of the at least some of the requesting user devices are associated with an individual one of the network operators of the collaboration, and
the re-branding comprises selecting the configuration information from the association table based on at least a mobile network code of the network operator with which the respective user device is a subscriber, and the configuration information is downloaded to the respective requesting user device automatically in response to an initial launch of the application on the respective user device.

18. The apparatus according to claim 13, wherein the memory with the set of computer executable instructions is configured with the at least one processor to cause the apparatus to further:
allocate respective shares of revenue generated by the application among the respective network operators of the collaboration, wherein the respective shares of revenue is based on the association of the requesting user devices with respective network operators of the collaboration.
